(19) United States
(12) Patent Application Publication
(10) Pub. No.: US 2006/0004930 A1
(43) Pub. Date: Jan. 5, 2006

(54) Expanded accessory identification

(76) Inventors: Joseph Patino, Pembroke Pines, FL (US); Sybren D. Smith, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/882,037

(22) Filed: Jun. 30, 2004

(51) Int. Cl. G06F 13/00

(52) U.S. Cl. 710/16

(57) ABSTRACT

A host device (500) is coupled to a peripheral device (104) which is initially not identified. To identify the peripheral device, the host device uses known information and information acquired from the peripheral device to determine the values of several electrical components (122) in the peripheral device. The host device applies different electrical conditions to the components by adjusting the state of I/O ports coupled to the peripheral device and measuring electrical conditions in response at other ports. Once sufficient information has been acquired, the measured values are used with known values of the system to calculate the values of the components in the peripheral device according to known electrical relationships.

### TECHNICAL FIELD

This invention relates in general to electronic devices that have a peripheral device interface for connecting to a variety of peripheral devices, and more particularly to methods for identifying which of the variety of peripheral devices is presently connected to a host device.

### BACKGROUND OF THE INVENTION

Portable electronic devices are in widespread use in everyday life throughout many regions of the world, and particularly in metropolitan regions. Examples of such devices include mobile communication devices, personal digital assistants and other handheld computer devices, cameras, and so on. Many of these devices are designed with an electrical interface that allows them to be used with accessory or peripheral devices such as external audio devices, cameras, wireless communication modules, for example. When a peripheral component is attached to the portable device, it is preferable that the portable device detect the presence of the peripheral component so that the portable device can instantiate appropriate driver software for operating the peripheral component. This presents two problems. First, how the presence of the peripheral component is detected, and second, determining which peripheral component is present so that the right driver software and/or operating mode may be initiated on the portable device.

Typically portable devices having external interface connectors provide power and a ground reference connection so that power may be provided to the peripheral device. Furthermore one or more option selector lines are provided at an interface so that the peripheral component or the class of the peripheral component may be determined.

One method of determining the identity of a peripheral device is with the use of coding resistors. Coding resistors are commonly used in battery pack for use with the portable device to indicate battery parameters such as, for example, battery capacity, battery chemistry type, and so on. However, if the interface is also to support other types of peripheral components, than a simple coding resistor scheme is too limited to indicate the wide variety of peripheral components in low cost applications.

Therefore there is a need for a means by which more peripheral components or peripheral component classes may be defined with a limited number of option select lines.

### BRIEF DESCRIPTION OF THE DRAWINGS

FIG. 1 shows a block circuit schematic diagram of host device coupled to a peripheral device at an interface, in accordance with one embodiment of the invention;

FIG. 2 shows a peripheral device having a T component network;

FIG. 3 shows a peripheral device having a PI component network;

FIG. 4 shows a schematic diagram of peripheral device containing a battery cell or cells, in accordance with one embodiment of the invention;

FIG. 5 shows a schematic block diagram of a host device for use with one embodiment of the invention; and

FIG. 6 shows a flow chart diagram of a method of identifying a peripheral device, in accordance with one embodiment of the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem of having a limited number of electrical lines for identifying a peripheral device by placing a component network such as a resistor network inside the peripheral device having a plurality of components connected between a pair of ports, and by selectively applying and observing voltage in alternate steps, the host device can determine the values of all of the components in the network. Once the values are determined, the host device can correlate them with a peripheral device identification, such as by use of a look-up table in the host device's memory. Furthermore, it is contemplated that one or more of the components may have values that change according to conditions, allowing the host to ascertain the state of the peripheral device.

Referring now to FIG. 1, there is shown a block circuit schematic diagram 100 of host device 102 coupled to a peripheral device 104 at an interface 106. The host device may be, for example, a mobile communication device, laptop computer, personal digital assistant, or any one of a number of electronic devices to which accessories or peripheral devices may be attached. In one embodiment of the invention it is contemplated that the peripheral device includes at least one battery cell for providing power to the host device, but my be, or include, for example, a remote microphone, computer link cable assembly, or any of a variety or accessories of peripheral devices. The host device includes an input/output (I/O) array 108 for providing a first port 110 and a second port 112. On the host side 102 the ports may be referred to as first and second host ports, while on the peripheral side the ports may be referred to as peripheral ports. The first and second host ports are coupled electrically to the first and second peripheral ports, respectively. By port it is meant an electrical connection for providing information to the host device and acquiring information from the peripheral device. In one embodiment of the invention the information is indicated by a voltage level on the port. The voltage at the port may be read by a voltage quantizing means, such as an analog to digital converter which may be provided in the I/O array 108. Furthermore, the host device can assert information on the port by, for example, manipulating the state of a first I/O port 114 and a second I/O port 116, which are coupled to the first and second ports 110, 112, respectively, through a first known resistance 118, and a second known resistance 120, also respectively, which may be referred to as I/O resistors. The I/O ports are configurable to at least three states, which include low, high, or high impedance. By high it is meant that the output voltage is substantially equal to a known supply voltage. By low it is meant that the output voltage is substantially zero, or ground. By high impedance it is meant that the I/O port acts as an input and appears to be a very high electrical impedance looking into the I/O port, such that it may be effectively treated as an infinite impedance or open circuit. It will be appreciated by those skilled in the art that while described as providing effectively a logic high and low, similar results can be achieved by using any two significantly different voltage levels at the I/O ports, or by simply switching in different voltages, as will be described subsequently. Disposed within the peripheral device 104 is a component network 122 of electrical components, such as a resistor network. The network 122 is connected between the first and second ports, and a ground port 124 common to both the host and peripheral sides. At least one of the components within the network 122 selected to correspond with one of a plurality of known values that are used to indicate the identity of the peripheral device.

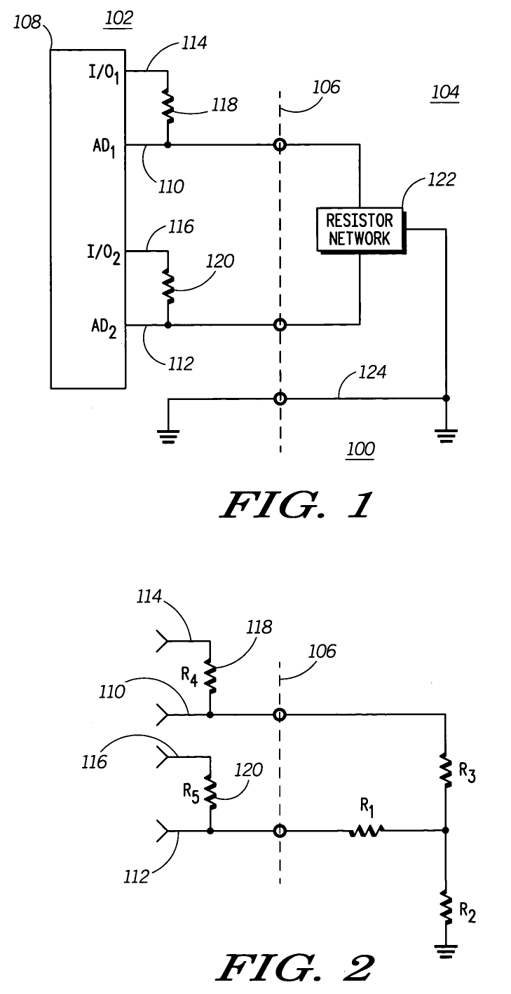

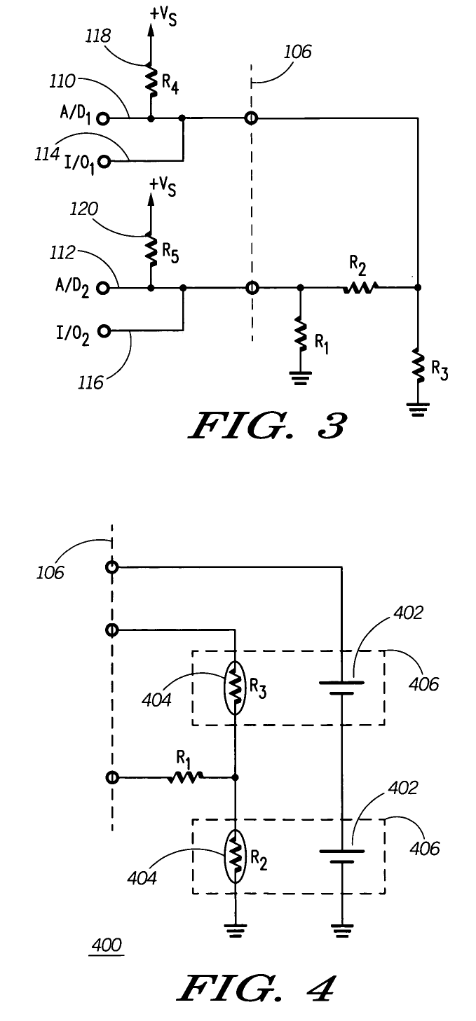

Referring now to FIGS. 2 and 3, there are shown a peripheral device having a T and PI component network, respectively, disposed therein. The networks are comprised of three resistors, in accordance with one embodiment of the invention, labeled R₁, R₂, and R₃. Similarly, the first and second I/O resistors are labeled R₄, R₅, respectively.

To illustrate how the host device can determine the values of the network components in the peripheral device, beginning with the T network shown in FIG. 2, the host device first I/O port 114 to a known high voltage level, and the second I/O port 116 to a high impedance state, and a first voltage reading V₁ is read at the first port 110. Because the second I/O port 116 is configure as a high impedance, and, as is known, the input to the A/D at the second port 112 is also a high impedance, the voltage sourced by the first I/O port 114 is divided among R₄, R₃, and R₂, proportionally. Thus the voltage at the first port is the voltage evident across R₂ and R₃, which is found as:

$${V}_{1} = ( {V}_{s} ) \frac{{R}_{3} + {R}_{2}}{{R}_{4} + {R}_{3} + {R}_{2}} \qquad ( 1 )$$

Where Vₛ is the voltage sourced by the first I/O port.

A second voltage V₂ reading may be acquired by configuring the first I/O port 114 as a high impedance, and the second I/O port 116 as a high, and measuring the voltage at the second port 112. When so configured, because the first I/O port 114 and first port 110 are high impedance, no significant current flows through R₃, R₄, so the voltage sourced by the second I/O port 116 is divided proportionally across R₅, R₁, and R₂. Thus V₂ is found as:

$${V}_{2} = ( {V}_{s} ) \frac{{R}_{1} + {R}_{2}}{{R}_{5} + {R}_{1} + {R}_{2}} \qquad ( 2 )$$

Where Vₛ is the voltage sourced by the second I/O port 116, which will preferable be the same as the voltage sourced by the first I/O port 114 in acquiring V₁, above.

A third voltage measurement V₃ may be acquired at the first port 110 by configuring the first I/O port 114 as a high impedance, the second I/O port 116 as a high, and reading the voltage at the first port 110. With the first I/O port 114 configured in a high impedance state, no current flows through R₃, so the voltage sourced by the second I/O port 116 is divided across R₅, R₁, and R₂ proportionally, and the voltage at the first port 110 is equal to the voltage evident across R₂. Thus, V₃ is found as:

$${V}_{3} = ( {V}_{s} ) \frac{{R}_{2}}{{R}_{5} + {R}_{1} + {R}_{2}} \qquad ( 3 )$$

Where Vₛ, is the voltage sourced by second I/O port 116.

A fourth voltage measurement V₄ may be acquired at the second port 112 by configuring the first I/O port 114 as a high, and the second I/O port 116 as in a high impedance state. So configured, no significant current will flow through R₁, R₅, and the voltage sourced by the first I/O port 114 will be proportionally divided across R₄, R₃, and R₂, with the voltage evident at the second port being the voltage across R₂. Thus, V₄ is found as:

$${V}_{4} = ( {V}_{s} ) \frac{{R}_{2}}{{R}_{4} + {R}_{3} + {R}_{2}} \qquad ( 4 )$$

Where Vₛ is the voltage sourced by the first I/O port 114.

After acquiring the four voltage readings, the values of R1, R2, and R3 may be determined, according to one embodiment of the invention, as follows, solving first for R₁:

First, solve for R₂ in terms of R₁, starting with V₃:

$${V}_{3} = ( {V}_{s} ) \frac{{R}_{2}}{{R}_{5} + {R}_{1} + {R}_{2}} \qquad ( 5 )$$

Which, solving for R₂ yields:

$${R}_{2} = ( {V}_{3} ) \frac{{R}_{5} + {R}_{1}}{{V}_{s} - {V}_{3}} \qquad ( 6 )$$

Substituting the right side of which into the equation for V₂ yields:

$${V}_{2} = ( {V}_{S} ) \frac{{R}_{1} + \frac{{V}_{3} ( {R}_{5} + {R}_{1} )}{( {V}_{S} - {V}_{3} )}}{{R}_{5} + {R}_{1} + ( \frac{{V}_{3} ( {R}_{5} + {R}_{1} )}{{V}_{S} - {V}_{3}} )} \qquad ( 7 )$$

Which reduces to yield:

$${V}_{2} = \frac{{R}_{1} {V}_{S} + {R}_{5} {V}_{3}}{{R}_{5} + {R}_{1}} \qquad ( 8 )$$

And solving for R₁ yields:

$${R}_{1} = \frac{{R}_{5} ( {V}_{2} - {V}_{3} )}{( {V}_{S} - {V}_{2} )} \qquad ( 9 )$$

And because R₅, V₂, V₃, and V₅ are all known, or directly measured in the steps above, R1 may be calculated by substituting in the actual values for R₅, V₂, V₃, and V_{S}.

By substituting the right side of equation (9) for R₁ into equation (6) above, and solving for R₂ yields:

$${R}_{2} = \frac{( {V}_{3} ) ( {R}_{5} ) ( 1 + \frac{{V}_{2} - {V}_{3}}{{V}_{S} - {V}_{2}} )}{( {V}_{S} - {V}_{3} )} \qquad ( 10 )$$

Because all of the variables on the right side of equation (10) are known quantities, R₂ can now be determined by substituting in the known or measured values for each variable and calculating the value of R₂.

To find the value of R₃, starting with equation (4) and solving for R₃ yields:

$${R}_{3} = \frac{( {R}_{2} ) ( {V}_{S} - {V}_{4} ) - ( {V}_{4} ) ( {R}_{4} )}{{V}_{4}} \qquad ( 11 )$$

Which, if R₂ has been determined, allows R₃ to be determined subsequently. However, if by substituting the right side of equation (10) into equation (11) for R₂, and reducing through algebraic operation, it will be found that R₃ may likewise be expressed in terms of known or measured quantities according to equation (12):
R₃=(V_{S}−V₃)[(V₃R₅)(_{V}_{S}−V₄)−(V₄R₄)(V₃−V₂)] (12)

Thus, all of the values of the T resistor network shown in FIG. 2 can be determined by acquiring the voltage readings V₁, V₂, V₃, and V₄. No calculation is needed, these are simply directly measured once the I/O ports are set to the specified states. These values are then used along with the known values of V_{S}, R₄, and R₅ and equations (9), (10), and (11) or (12) to determine the values of the resistors in the T network disposed in the peripheral device. Once these values are found, the host device can easily correlate them with a peripheral identification via, for example, a look up table disposed in a memory of the host device.

Similarly, for the embodiment of the invention shown in FIG. 3, the values of the electrical components, in this embodiment a PI configuration of resistors, may also be determined according to the invention. The three resistors in the peripheral device are again labeled R₁, R₂, and R₃. However, here the first and second port lines 110, 112 are both coupled to V_{S} through pull-up resistors R₄, R₅, respectively, and the first and second I/O ports 114, 116 are tied to the first and second ports. As with the previous embodiment, the method aspect of-the invention commences by setting the first and second I/O ports 114, 116 to preselected states, and reading a voltage at the ports 110, 112. To illustrate how the resistors of the PI configuration may be determined, a first voltage reading may be acquired by setting the first I/O port 114 as a low, which is a known voltage level, and in the preferred embodiment is substantially ground, or zero. The second I/O port 116 is configured to a high impedance. Placing the first I/O port 114 to a low state effectively grounds R₄ and R₃ out of the network, leaving R₁ and R₂ in parallel, and in a voltage dividing configuration with R₅. Therefore the voltage V₁ at the second port 112 is found as:

$${V}_{1} = \frac{{V}_{S} [ \frac{{R}_{1} {R}_{2}}{R1 + R2} ]}{[ {R}_{5} + \frac{{R}_{1} {R}_{2}}{{R}_{1} + {R}_{2}} ]} \qquad ( 13 )$$

Where V_{S} is the pull-up voltage to which R₅ is connected.

A second voltage reading V₂ is acquired by, for example, setting the second I/O port 116 to a low, effectively grounding R₅, setting the first I/O port 114 to a high impedance state, and measuring at the first port 110. So configured, R₂ and R₃ are effectively in parallel, and in series with R₄ such that the pull-up voltage sourced through R₄ is divided across R₂ and R₃ proportionally. Thus, V₂ is found as:

$${V}_{2} = \frac{{V}_{S} [ \frac{{R}_{2} {R}_{3}}{{R}_{2} + {R}_{3}} ]}{[ {R}_{4} + \frac{{R}_{2} {R}_{3}}{{R}_{2} + {R}_{3}} ]} \qquad ( 14 )$$

and solving for R₂ yields:

$${R}_{2} = \frac{{V}_{2} {R}_{4} {R}_{3}}{[ {V}_{S} {R}_{3} - {V}_{2} {R}_{4} - {V}_{2} {R}_{3} ]} \qquad ( 15 )$$

which results in R₂ being expressed with only one unknown, which is R₃.

A third voltage reading V₃ may be acquired by setting the first I/O port 114 to the high impedance state; the second I/O port 116 to a high, which is substantially equal to V_{S}, and measuring the voltage at the first port 110. So configured, R₂ and R₄ appear in parallel between V_{S} and the first port. Therefore V₃ is:

$${V}_{3} = \frac{{V}_{S} {R}_{3}}{{R}_{3} + \frac{{R}_{2} {R}_{4}}{{R}_{2} + {R}_{4}}} \qquad ( 16 )$$

Then it is a matter of substituting the right hand side of equation (15) in for R₂ in equation (16), reducing, and solving for R₃, which yields:

$${R}_{3} = \frac{{R}_{4} {V}_{2}}{{V}_{S} - {V}_{3}} \qquad ( 17 )$$

which results in R₃ being expressed in known quantities, which facilitates simple computation of the value of R₃.

Once the value of R₃ is determined, the value can then be used in equation (15) to determine the value of R₂ as all variable on the right hand side will have a definite value after determining the value of R₃. Finally, R₁ can be found from solving equation (13) for R₁, which yields:

$${R}_{1} = \frac{{V}_{1} {R}_{5} {R}_{2}}{{V}_{S} {R}_{2} - {V}_{1} {R}_{5} - {V}_{1} {R}_{2}} \qquad ( 18 )$$

where, the value of R₂ having been determined in equation (15) after obtaining the value of R₃ in equation (17), R₁ can be likewise determined as the value of all variable on the right hand side of equation (18) are known. Once the values of R₁, R₂, and R₃ are determined, then the host device determines the identity of the peripheral device by correlating the three values within, for example, a look-up table in a memory of the host device.

Referring now to FIG. 4, there is shown a schematic diagram 400 of peripheral device containing a battery cell or cells 402, in accordance with one embodiment of the invention. The battery cells 402 may be used to provide power to the host device, and may also provide power to circuitry in the peripheral device. The host device may also charge the battery cells by providing a charging current to the battery cells. In charging the battery cells, it is important to do so only when the temperature of the battery cells is within a specified temperature range. To determine the temperature of the battery cells, one or more elements of the identification network are temperature sensitive components, such as, for example, a thermistor 404. Each thermistor 404 is thermally coupled, by proximity or physical contact, with a battery cell. In the embodiment shown, R₁ of the network is a fixed value resistor while resistors R₂, and R₃ are thermistors. When the values of R₁, R₂, and R₃ are first determined, the value of R₁ can be used to identify the peripheral device, while the values of R₂, and R₃ can be used to determine the temperature of the battery cells. The values of R₂ and R₃ can periodically be recalculated to determine temperature changes of the battery cells. By doing so, the invention eliminates the need for additional port lines and connections between the host and peripheral devices, thereby eliminating the cost and reliability issues associated with additional contact points.

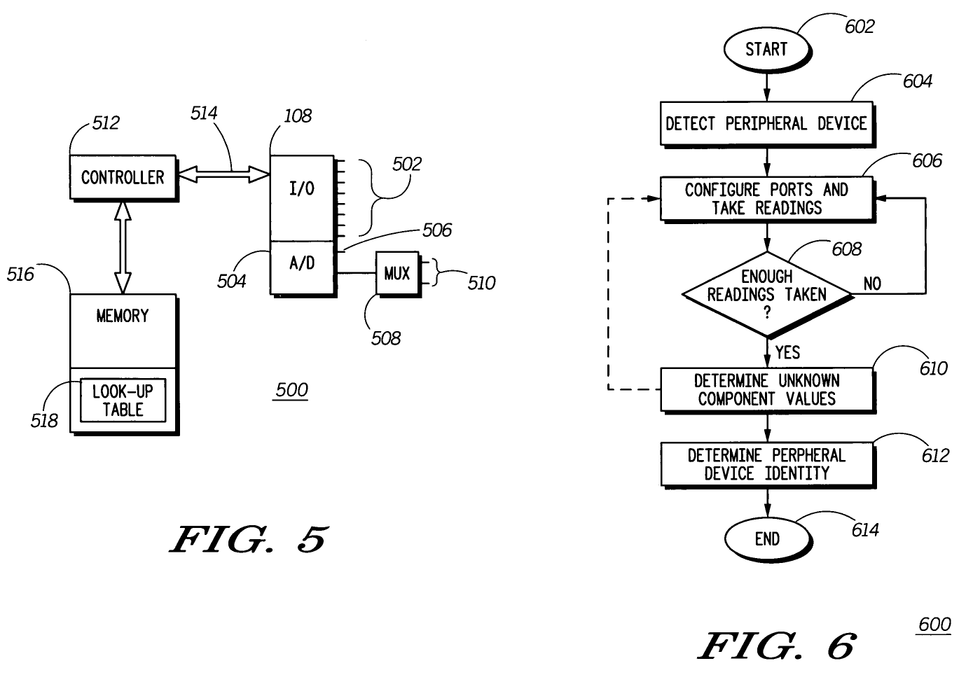

Referring now to FIG. 5, there is shown a schematic block diagram 500 of a host device for use with one embodiment of the invention. The host device may be, for example, a mobile communication device or portable computer, or any of a variety of devices to which peripheral devices may be connected. The host device comprises an I/O array 108, which provides one or more I/O lines or ports 502, and may optionally include an measurement means such as an analog to digital converter (A/D) 504. The A/D has at least one input 506 and may have additional inputs, or it may use a multiplexer 508 to alternatively connect several lines 510 to a single A/D input. The I/O array 108 is coupled to a controller 512 by a bus 514 over which the controller exchanges information with the I/O array. For example, to configure the various I/O ports to desired states, the controller may simply write a digital word to an I/O control buffer in the I/O array, where each bit of the digital word controls the state of corresponding I/O port, and each I/O port can be configured to be an input or an output, and as an output it can be configured to be a “low” or a “high.” The controller can receive data from the I/O array, such as data produced by the A/D, and the values of logic levels at the I/O ports when the ports are configured as inputs. The controller operates according to instruction code stored, for example, in a memory 516, which may include a means for correlating information received from the peripheral device about the identification network therein with identification files, such as a look-up table 518. Once the controller determines the values of the elements in the component network 122, the controller searches the look-up table to determine with which peripheral device the values correspond, and thus determine the identity of the peripheral device.

Referring now to FIG. 6, there is shown a flow chart diagram 600 of a method of identifying a peripheral device, in accordance with one embodiment of the invention. At the start 602 of the method a peripheral device is coupled to the host device, and the various ports are electrically connected together with their corresponding lines of the peripheral device. The host does not know what the peripheral device is, or how to interact with it. First, the host must detect the presence of the peripheral device, such as by, for example, occasionally or periodically polling the I/O ports, or by generating an interrupt when the peripheral device is coupled to the host device. Once the peripheral device is detected, the host device commences configuring the I/O ports (606) and determining the effect of the I/O configurations, such as by reading the resulting voltage levels at certain ports. This process is repeated until enough information is acquired (608). Once enough information is acquired, the host device determines the values of the components in the network disposed in the peripheral device (610). In some cases the some of the component values may change over time with changing characteristics of the peripheral device, such as, for example, temperature, and in which case the process is repeated as indicated by the dashed line to block 606. Once the component values have been determined, the host device commences identifying the peripheral device (612) by correlating the component values with a peripheral device identity file. The process ends (614) once the peripheral device is identified, and the host device and peripheral device interact accordingly. The host device may subsequently commence instantiating a software driver or application corresponding to the peripheral device and for use with the peripheral device.

Thus, the invention provides for a method of identifying a peripheral device connected to a mobile communication device, and commences with the coupling of the peripheral device to the mobile communication device. The coupling occurs at a first peripheral port, a second peripheral port, and a ground port, and each of the first and second peripheral ports are coupled to first and second I/O port, respectively, through a known resistance. Each I/O port is configurable to a low logic level, high logic level, or high impedance state. Once the coupling occurs, the host device commences acquiring voltage readings by configuring the first I/O port to a known voltage level, the second I/O port to the high impedance state, and determining the voltage at the first and second peripheral ports. Then by acquiring third and fourth voltage readings by configuring the second I/O port to a known voltage level, the first I/O port to the high impedance state, and determining the voltage at the first and second peripheral ports. Once sufficient information has been acquired, the mobile communication device commences determining the values of a plurality of resistors of a resistor network disposed in the peripheral device that is coupled between the first and second peripheral ports and the ground port These values are determined with the first, second, third, and fourth voltage readings. Once the values of the resistors are known, the mobile communication device commences correlating a peripheral device identification with the resistance values to identify the peripheral device. It is contemplated that at least one of the resistors is a thermistor, and the method further includes determining the temperature or temperature change of the peripheral by the thermistor resistance value. Thermistors would be used, for example, to control charging of a battery cell disposed within the peripheral device. In the preferred embodiment, three resistors are used. More could be used with additional I/O ports and additional steps in determining their values. The three resistors may be arranged in a T or a PI network configuration.

Furthermore, the invention also provides a method of identifying a peripheral device for use with a host device, which commences upon electrically coupling the peripheral device to the host device at first, second, and ground ports. Then by determining the values of each of a plurality of electrical components disposed in the peripheral device between the first, second, and ground ports. The determination of component values is performed by acquiring voltage values at the first and second ports in response to adjusting electrical conditions at the first and second ports and using known electrical relationships such a shown in equations (1) thought (18) to calculate the values of the components with the known or acquired information. Once the values are determined, the host device commences correlating the values with a peripheral device identification to identify the peripheral device. It is contemplated that determining the values of the components is performed by determining a resistance value of each of three resistors by acquiring 2 voltage values at both of the first and second ports under different electrical conditions at the I/O ports. While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of identifying a peripheral device connected to a mobile communication device, comprising:
coupling the peripheral device to the mobile communication device at a first peripheral port, a second peripheral port, and a ground port, and wherein each of the first and second peripheral ports is coupled to a first and second I/O port, respectively, through a known resistance, and is configurable to one of a low logic level, high logic level, or high impedance state;
acquiring first and second voltage readings by configuring the first I/O port to a known voltage level, the second I/O port to the high impedance state, and determining the voltage at the first and second peripheral ports;
acquiring third and fourth voltage readings by configuring the second I/O port to a known voltage level, the first I/O port to the high impedance state, and determining the voltage at the first and second peripheral ports;
determining the values of a plurality of resistors of a resistor network disposed in the peripheral device and coupled between the first and second peripheral ports and the ground port with the first, second, third, and fourth voltage readings using known electrical relationships; and
correlating a peripheral device identification with the plurality of resistance values.

2. A method of identifying a peripheral device as defined in claim 1, wherein at least one of the plurality of resistors is a thermistor, the method further comprising determining a temperature of the peripheral device.

3. A method of identifying a peripheral device as defined in claim 2, further comprising using the temperature of the peripheral device for charging at least one battery cell disposed within the peripheral device.

4. A method of identifying a peripheral device as defined in claim 1, wherein the plurality of resistors is a three resistor network.

5. A method of identifying a peripheral device as defined in claim 4, wherein the three resistor network is a T network.

6. A method of identifying a peripheral device as defined in claim 4, wherein the three resistor network is a PI network.

7. A method of identifying a peripheral device for use with a host device, comprising:
electrically coupling the peripheral device to the host device at first, second, and ground ports;
determining the values of each of a plurality of electrical components disposed in the peripheral device between the first, second, and ground ports, performed acquiring voltage values at the first and second ports in response to adjusting electrical conditions at the first and second ports; and
correlating the values of the plurality of electrical components with a peripheral device identification.

8. A method of identifying a peripheral device as defined in claim 7, wherein determining the values of the plurality of electrical components comprises determining a resistance value of each of three resistors by acquiring 2 voltage values at each of the first and second ports under different electrical conditions.

9. A method of identifying a peripheral device as defined in claim 8, wherein determining the values of the three resistors comprises determining the resistance values of three resistors arranged in a T network.

10. A method of identifying a peripheral device as defined in claim 8, wherein determining the values of the three resistors comprises determining the resistance values of three resistors arranged in a PI network.

11. A system for identifying a peripheral device by a host device, comprising:
first and second host ports disposed in the host device, each of the host ports coupled to voltage quantifying means, and each of the host ports coupled to its own I/O port through a separate I/O resistor;
first and second peripheral ports disposed in the peripheral device for electrically coupling to the first and second device ports; and
a resistance network comprised of a plurality of resistors electrically coupled between the first and second peripheral ports and a ground line common to both the peripheral and host devices, of the plurality of resistors having a resistance value;
wherein the host device adjusts electrical conditions at the I/O ports and acquires voltage values at the host ports with the voltage quantifying means to determine the resistance values of the resistor network and to correlate the resistance values to a peripheral device identification.

12. A system for identifying a peripheral device by a host device as defined in claim 11, wherein the resistance network comprises three resistors arranged in a T configuration.

13. A system for identifying a peripheral device by a host device as defined in claim 11, wherein the resistance network comprises three resistors arranged in a PI configuration.

14. A system for identifying a peripheral device by a host device as defined in claim 11, wherein only four voltage values are acquired by the host device, 2 at each of the first and second host ports.

15. A system for identifying a peripheral device by a host device as defined in claim 11, wherein at least one of the plurality of resistors of the resistance network is a thermistor.

16. A system for identifying a peripheral device by a host device as defined in claim 15, wherein the thermistor is used to indicate a temperature of a battery cell disposed in the peripheral device.
